(19) United States
(12) Patent Application Publication
(10) Pub. No.: US 2025/0190207 A1
(43) Pub. Date: Jun. 12, 2025

(54) SYSTEM AND METHOD FOR UPDATING FIRMWARE WITH AN NFC READER

(71) Applicant: STMICROELECTRONICS (CHINA) INVESTMENT CO., LTD, Shanghai (CN)

(72) Inventors: Tianhao XIONG, Shanghai (CN); Gang WU, Shanghai (CN)

(73) Assignee: STMICROELECTRONICS (CHINA) INVESTMENT CO., LTD., Shanghai (CN)

(21) Appl. No.: 18/846,577

(22) PCT Filed: Mar. 16, 2022
(86) PCT No.: PCT/CN2022/081144

§ 371 Date: Sep. 12, 2024

(51) Int. Cl. G06F 8/65

(52) U.S. Cl. CPC G06F 8/65

(57) ABSTRACT

A near field communication (NFC) system utilizes an NFC reader in reader mode to update firmware of a controller associated with the NFC reader. An NFC device receives firmware update data. The NFC reader, operating in reader mode, reads the firmware update data from the NFC device.

### BACKGROUND

### Technical Field

The present disclosure relates to the field of near field communication (NFC). The present disclosure relates more particularly to upgrading firmware of an NFC reader.

### Description of the Related Art

NFC technology utilizes radiofrequency signals to enable devices to communicate with each other in close proximity. Many applications of NFC technology utilize an NFC reader to interrogate and receive data from an NFC device. The NFC reader typically outputs an interrogation signal. If an NFC device is within range of the interrogation signal, then the NFC device responds by providing an identification signal identifying the NFC device. After the NFC device has identified itself, the NFC reader and the NFC device can further exchange information.

NFC readers may include a controller that controls the function of the NFC reader. The controller may include firmware. Firmware corresponds to software that defines or controls the basic function of the NFC reader. In some cases, it may be beneficial to upgrade the firmware of an NFC reader. However, it can be relatively difficult to upgrade the firmware of an NFC reader.

In many cases, an NFC reader is part of an electronic device or electronic system that performs primary functions aside from NFC communication. Upgrading the firmware in these devices or systems can also be difficult. In particular, upgrading firmware can include time-consuming and inconvenient procedures.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

Embodiments of the present disclosure provide NFC readers that are able to perform firmware updates for controllers in a simple and effective manner. An NFC reader operating in reader mode can detect the presence of an NFC device that includes firmware update data for a controller associated with the NFC reader. The NFC reader reads the firmware update data from the NFC device and provides the firmware update data to the controller. The controller can then update its firmware.

Many NFC devices are able to easily connect to the Internet in order to download a firmware update for a controller associated with the NFC reader. A user of the NFC device can manually request a firmware update for the controller. Alternatively, a system associated with the NFC reader can push a firmware update onto the NFC device via the Internet. The NFC device can then provide a notification that a firmware update is available for a controller associated with an NFC reader. A user can then bring the NFC device in proximity to the NFC reader. The NFC reader, operating in reader mode, establishes communication with the NFC device and reads the firmware update data from the NFC device. The NFC reader then provides the firmware update data to the controller associated with the NFC reader.

In one embodiment, a mobile phone is an NFC device. The mobile phone may include an application that receives a firmware update for the controller associated with the NFC reader. The mobile phone may then indicate to the user that a firmware update is available. The mobile phone may enter an NFC card emulation mode in which the mobile phone emulates a simple NFC tag or card. The NFC reader establishes communication with the mobile phone acting as an NFC tag or card and reads the firmware data from the mobile phone just as the NFC reader might read data from a passive NFC device.

In one embodiment, the controller for which a firmware update is available controls the NFC reader. The firmware update includes firmware that controls the NFC reader. Upon reading the firmware update data from the NFC device, the controller updates its firmware. The controller may be within the NFC reader or may be a controller in an electronic device that hosts the NFC reader and controls the NFC reader.

In one embodiment, the controller for which the firmware update is available is a controller of an electronic device or system that hosts the NFC reader. In these cases, the NFC reader can be utilized to quickly and efficiently update the firmware of a controller that controls the electronic system or electronic device. In some cases, the NFC reader may receive firmware update data for a controller of the NFC reader and for a controller of the host electronic system or electronic device.

Embodiments of the present disclosure provide an NFC based firmware update process that is both simple and efficient. This obviates processes in which intrusive equipment and manual access procedures are utilized to perform firmware updates for NFC readers and for associated electronic devices and systems.

### BRIEF DESCRIPTION OF THE SEVERAL VIEWS OF THE DRAWINGS

FIG. 1 is a block diagram of an NFC system, according to one embodiment.

FIG. 2 is a block diagram of an NFC system, according to one embodiment.

FIG. 3 is a block diagram of an NFC system, according to one embodiment.

FIG. 4A is a block diagram of an NFC system, according to one embodiment.

FIG. 4B is a block diagram of an NFC system, according to one embodiment.

FIG. 5 is a flow diagram of a process for operating an NFC system, according to one embodiment.

FIG. 6 is a flow diagram of a process for operating an NFC system, according to one embodiment.

FIG. 7 is a flow diagram of a process for operating an NFC system, according to one embodiment.

### DETAILED DESCRIPTION

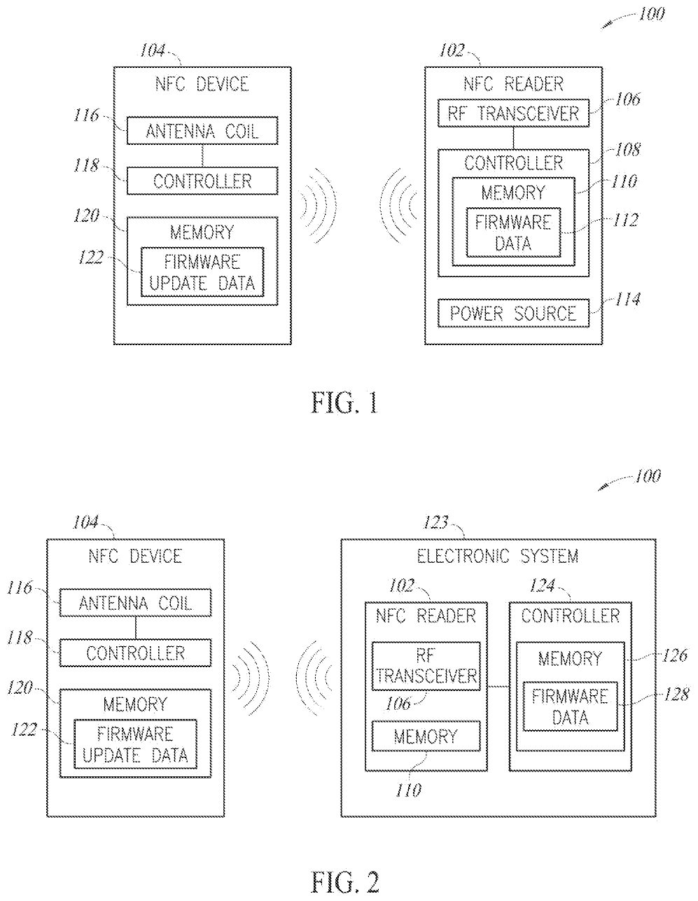

FIG. 1 is a block diagram of an NFC system 100, according to one embodiment. The NFC system 100 includes an NFC reader 102 and an NFC device 104. The NFC reader 102 and the NFC device 104 communicate with each other utilizing NFC technology. As will be set forth in more detail below, the NFC reader 102 and the NFC device 104 cooperate to quickly and efficiently update the firmware of the controller associated with the NFC reader 102.

Prior to describing further details of the NFC system 100, it is beneficial to describe some operating modes of NFC readers. A first operating mode of an NFC reader is a read/write mode, hereafter referred to as “reader mode”. In the reader mode, the NFC reader outputs a carrier signal corresponding to a radiofrequency signal that facilitates NFC communication. The NFC reader outputs an interrogation signal by modulating the carrier signal. If an NFC device is in proximity to the NFC reader, the NFC device may receive the interrogation signal. The interrogation signal induces a response from the NFC device. Once communication is established between the NFC reader and the NFC device, the NFC reader may read data from the NFC device. Further details regarding reader mode of the NFC reader are provided below.

A second operating mode of an NFC reader is a card emulation mode. In the card emulation mode, the NFC reader 102 acts as an NFC device. In this case, the NFC reader 102 may act in a similar manner to the way an NFC device acts when the NFC reader is in reader mode. In this case, another NFC reader may read data from the NFC reader.

A third operating mode of the NFC reader is a peer-to-peer operating mode. In this case, the NFC reader may communicate with another NFC reader. In peer-to-peer operating mode, both NFC readers take an active role and may each actively provide data to the other. One example of such an operating mode is when two NFC capable mobile phones transfer business cards or exchange other types of data with each other.

As used herein, an “NFC reader” corresponds to a device that operates in reader mode by outputting a carrier signal in order to identify and interrogate nearby NFC devices. The NFC reader reads data from the NFC device. As used herein, an “NFC device” is a device that operates as an NFC tag or card when interacting with the NFC reader in reader mode. An NFC tag receives the carrier field and interrogation signal from an NFC reader and responds by providing data to the NFC reader by NFC. The NFC tag may be an entirely passive device that is energized by the carrier signal. Alternatively, the NFC tag may be an active NFC tag with its own power source but that responds in a similar manner as an NFC tag. In practice, an NFC device may be capable of being operated as an NFC reader. However, in the present disclosure, the NFC device is a device that plays a role of an NFC device in processes described herein, regardless of whether the NFC device is capable of operating in other manners.

The NFC reader 102 includes an RF transceiver 106, a controller 108, and a power source 114. The components of the NFC reader 102 cooperate together to provide NFC communication.

The RF transceiver 106 enables the NFC reader 102 to transmit signals and to receive signals. The RF transceiver 106 can include one or more antennas for transmitting NFC signals and for receiving NFC signals. The RF transceiver 106 can include additional circuitry for enabling the RF transceiver 106 to transmit signals including interrogation signals, carrier signals, and other types of signals. The RF transceiver 106 can include additional circuitry for enabling the RF transceiver 106 to receive and process signals including interrogation signals and other types of signals from various types of NFC devices.

The controller 108 includes control circuitry for controlling the function of the NFC reader 102. The controller 108 controls the operation of the RF transceiver 106. The controller 108 controls the transmission of signals with the RF transceiver 106. The controller 108 also controls the reception of signals with the RF transceiver 106. The controller 108 can include processing resources, memory resources, and data transmission resources. The controller 108 may correspond to a microcontroller, a microprocessor, or other types of controllers or processors.

The controller 108 includes a memory 110. The memory 110 may include electrically erasable and programmable read-only memory (EEPROM), random access memory (RAM), and other types of memory. The EEPROM can include flash memory or other types of memory. The RAM may include static RAM (SRAM), dynamic RAM (DRAM), or other types of RAM.

The memory 110 stores firmware data 112. The firmware data 112 is software that controls the basic function of the controller 108. Because the controller 110 controls the function of the NFC reader 102, and because the firmware data 112 defines operation of the controller 108, the firmware data 112 effectively controls the function of the NFC reader 102. The firmware data may act as the operating system of the NFC reader 102. The firmware data 112 can include instructions protocols for performing the operations, processes, and methods executed by the NFC reader 102, including those described herein. As will be set forth in more detail below, the components of the NFC system 100 cooperates to update the firmware data 112 of the controller 108.

While the embodiment of FIG. 1 illustrates a controller that is part of the NFC reader 102, the controller may also be part of a device or system that hosts the NFC reader 102. The processes described here for updating the firmware associated with the controller 108 that controls the NFC reader 102 can be utilized to update the firmware for other controllers of an electronic device or system that hosts the NFC reader 102. The firmware data associated with these other controllers may be more complex than the firmware data 112 associated with the NFC reader 102.

From time to time it may be beneficial to update the firmware data 112 of the controller 108. In many instances it may be difficult to update the firmware data 112 of a controller associated with an NFC reader. This may be particularly true when an NFC reader is part of a device that is not commonly connected to the Internet, or that does not have a ready interface that allows the user to navigate the Internet to update firmware. In one example, an NFC reader is part of an automobile. For example, the NFC reader may be part of a system that enables a user to present an NFC device in order to gain access to the automobile. The NFC reader of the automobile reads an identification from the NFC device and unlocks the doors of the automobile or starts the engine of the automobile. Because the automobile does not have a convenient interface by which a user may initiate a firmware update of the controller, it can be very difficult to update the firmware of the controller associated with the NFC reader of the automobile. In many instances, in order to update the firmware of the controller associated with the NFC reader, or other controllers in the automobile, the user takes the automobile to an automobile dealership associated with the maker the automobile. The technician at the dealership may then use specialized equipment to physically connect an updater board to electronic systems of the automobile in order to update firmware of the controller associated with the NFC reader, or with other controllers. Such a process can be time-consuming, expensive, and highly inconvenient.

In another example, a wireless charging device includes an NFC reader. A user may place a mobile phone or another NFC ready device on the charging bay of the wireless charging device. The NFC reader initiates NFC communication with the mobile phone and, if the mobile phone is compatible, the wireless charging device may then initiate wireless charging. Again, it may be particularly difficult to update firmware associated with an NFC reader of such a wireless charging device. The user may need to use specialized tools and updater boards to access internal components of the wireless charging device in order to update the firmware of the wireless charging device. There are many other examples of electronic devices that include NFC readers and that have controllers for which firmware updates may be difficult to perform.

The NFC system 100 overcomes the drawbacks and difficulties associated with other solutions for updating firmware of controllers. The NFC reader 102 and the NFC device 104 of FIG. 1 provide a convenient, efficient, and effective way to update the firmware data 112 of the controller 108 associated with the NFC reader 102.

The NFC device 104 plays a role in updating the firmware data 112 of the NFC reader 102. The NFC device 104 includes an antenna coil 116, controller 118, and memory 120. The antenna coil 116 includes antennas and other circuitry for receiving signals from the NFC reader 102 and for providing signals to the NFC reader 102. The NFC device 104 may include an NFC transceiver including one or more antenna coils. The antenna coil 116 may be part of an NFC transceiver of the NFC device 104.

The controller 118 may controls the operation of the antenna coil 116. The controller 118 may control the modulation of output of signals from the antenna coil 116 responsive to interrogation signals received from the NFC reader 102. The controller 118 may control modulation of an impedance of the antenna coil 116.

The memory 120 may store software instructions associated with operating the NFC device 104. Though not shown in FIG. 1, the memory 120 may include firmware data of the controller 118. The memory 120 can include the same types of memories described in relation to the memory 110 of the NFC reader 102, or may include other types of memory.

The memory 120 may store a unique identification (UID) of the NFC device 104. The UID is identification code associated with the NFC device 104. The UID may also identify the type of the NFC device 104. As will be set forth in more detail below, the UID may be read by the NFC reader 102 in order to authenticate the NFC device 104 or to determine whether the NFC device 104 has permission to utilize functions of an electronic device or system associated with the NFC reader 102.

The memory 120 may also store an application identifier (AID). The AID indicates a type of application or process associated with the NFC device 104. An AID can identify a particular activity such as electronic payment, access authorization, or other types of functions that the NFC device 104 and the NFC reader 102 may perform together.

In one embodiment, the memory 120 stores an AID associated with a firmware update application. The NFC reader 102 may read AID from the NFC device 104 and may then initiate the process for updating the firmware data 112 of the controller 108 based on the AID. Various other types of AIDs and other identifications can be utilized without departing from the scope of the present disclosure.

The NFC device 104 is configured to receive firmware update data 122. The NFC device 104 stores the firmware update data 122 in the memory 120. The firmware update data corresponds to firmware data that will replace the firmware data 112 of the controller 108. Accordingly, the firmware update data 122 corresponds to a replacement for the firmware data 112 of the controller 108.

The NFC device 104 may receive the firmware update via the Internet, via a network connection, or in other ways. In one example, the NFC device 104 is a device that includes a user interface and an application associated with the NFC reader 102. The application may prompt the user of the NFC device 104 to download firmware update data 122 in preparation for performing a firmware update process of the controller 108. The user may then accept the firmware update data 122 or may otherwise select to download the firmware update 122. In another example, an application associated with the NFC device 104 may automatically download firmware update data 122 without user input. There are various ways in which an NFC device 104 may receive firmware update data 122.

In one embodiment, the NFC device 104 is a smart phone. The smart phone may include an application associated with the NFC reader 102. The application may download firmware update data 122 for the controller 108. Alternatively, the user may utilize an application to accept or request download of the firmware update data 122. The NFC device 104 can include smart watch, a tablet, and NFC card, an NFC tag, or other types of electronic devices that include NFC capability.

The NFC device 104 is configured to enter into an NFC card emulation mode. In the NFC card emulation mode, the smart phone behaves as a simple NFC tag or NFC card. In the card emulation mode, the NFC device responds to an interrogation signal from the NFC reader 102. The NFC reader 102 can then read data from the NFC device. As an example, the NFC device 104 can include a smart phone capable of operating in NFC card emulation mode.

After the NFC device 104 has downloaded or otherwise received the firmware update data 122, the user of the NFC device 104 brings the NFC device 104 into proximity of the NFC reader 102. The NFC reader 102 is operating in reader mode. In reader mode, the NFC reader 102 outputs a carrier signal and modulates the carrier signal to generate an interrogation signal. The NFC device 104, operating as an NFC tag, or in an NFC card emulation mode, receives the interrogation signal and is induced to respond to the interrogation signal. Initially, the NFC reader 102 reads an identification from the NFC device 104, for example a UID. After authenticating the NFC device 104, the NFC reader reads the AID from the NFC device 104. The AID indicates that the NFC device 104 wishes to provide firmware update data 122 to the NFC reader 102.

The NFC reader 102 reads the firmware update data 122 from the NFC device 104. The NFC reader 102 provides the firmware update data 122 to the controller 108. The controller 108 updates the firmware data 112 with the firmware update data 122. This corresponds to overriding the previous firmware data 112 with the firmware update data 122. After this process, the firmware data 112 corresponds to the firmware update data 122. In this way, the NFC reader 102 and the NFC device 104 cooperate to quickly and efficiently update the firmware data 112 without the need of intrusive, time-consuming, or inconvenient processes.

If the UID is not valid, then the NFC reader 102 enters a standard operation mode. If the UID is valid, but the AID is not valid, then the NFC reader 102 enters a standard operation mode. Other types of identification data and authentication processes can be utilized by the NFC reader 102 and the NFC device 104 without departing from the scope of the present disclosure.

In one embodiment, the NFC reader 102 outputs a carrier signal with the standard central frequency of 13.56 MHz. However other frequencies can be utilized by the NFC reader 102 without departing from the scope of the present disclosure.

The NFC reader 102 outputs a carrier signal. The carrier signal is a radiofrequency signal that facilitates NFC communication . . . The NFC reader 102 outputs an interrogation signal by modulating the carrier signal. The interrogation signal is configured to induce a response from NFC devices that are in communication range with the NFC reader 102. If the NFC device 104 is within range of the NFC reader 102, then the NFC device 104 can respond to the interrogation signal.

In one embodiment, the NFC device 104 is a passive load modulation NFC device 104. Passive load modulation NFC devices do not have their own power sources. Instead, passive load modulation NFC devices are powered by the carrier signal output from the NFC reader 102. Accordingly, passive load modulation NFC devices include energy harvesting circuitry that harvests energy from the carrier signal output by the NFC reader 102. As used herein, the term “passive NFC device” may be used interchangeably with the term “passive load modulation NFC device”.

Passive load modulation includes modifying the impedance of an antenna coil 116 of the passive NFC device at the rate of a data carrying load modulation signal. This impedance modulation is echoed by inductive coupling in the impedance of an antenna coil of the NFC reader 102. The NFC reader 102 can extract from its antenna signal the load modulation signal used by the passive NFC device. In this way, the NFC reader 102 can extract an identification or other data from the passive NFC device. Passive load modulation NFC devices as described herein can operate in accordance with well understood passive load modulation techniques. Because passive NFC devices are powered by energy harvested from the carrier signal, passive NFC devices modulate the impedance in accordance with the frequency of the carrier signal.

In one embodiment, the NFC device 104 is an active load modulation NFC device. Active load modulation NFC devices are powered by a power source separate from the NFC reader 102. Accordingly, when an active load modulation NFC device receives an interrogation signal, the active load modulation NFC device responds by outputting a radiofrequency signal and modulating the radiofrequency signal under the power of a power source separate from the NFC reader 102. Data is transmitted from the NFC device 104 by modulating the radiofrequency signal output by the NFC device 104. As used herein, the term “active NFC device” may be used interchangeably with the term “active load modulation NFC device”. Active load modulation can be achieved in other ways without departing from the scope of the present disclosure.

The power source 114 provides power to the NFC reader 102. The power source 114 can include one or more of an internal battery, a wired power connection to an external power source, and a wireless power connection to an external power source. Alternatively, the NFC reader 102 may be powered by a power source external to the NFC reader.

FIG. 2 is a block diagram of an NFC system 100, according to one embodiment. The NFC system includes an electronic system 123 and the NFC device 104. The electronic device 123 includes an NFC reader 102 and the controller 124. The electronic device 123 and the NFC device 104 cooperate to update the firmware of the controller 124.

The NFC device 104 of FIG. 2 is substantially identical to the NFC device 104 of FIG. 1. The electronic system 123 is a system that hosts the NFC reader 102. The electronic system 123 includes a controller 124 that controls the NFC reader 102. The controller 124 can include a microprocessor, a microcontroller, or another type of controlled.

The controller 124 includes a memory 126. The memory 126 may include electrically erasable and programmable read-only memory (EEPROM), random access memory (RAM), and other types of memory. The EEPROM can include flash memory or other types of memory. The RAM may include static RAM (SRAM), dynamic RAM (DRAM), or other types of RAM.

The memory 126 stores firmware data 128. The firmware data 128 is software that controls the basic function of the controller 124. Because the controller 124 controls the function of the NFC reader 102 and of other aspects of the electronic system 123, and because the firmware data 128 defines operation of the controller 124, the firmware data 128 effectively controls the function of the NFC reader and other aspects of the electronic system 123. The firmware data may act as the operating system of the NFC reader 102. The firmware data 128 can include instructions protocols for performing the operations, processes, and methods executed by the NFC reader 102 and other aspects of the electronic system 123, including those described herein. As will be set forth in more detail below, the NFC system 100 cooperate to update the firmware data 128 of the controller 124.

When a firmware update is available for the controller 124, the NFC device 104 receives firmware update data 122. The firmware update data 122 can be received with permission request of a user of the NFC device 104, or without knowledge of the user of the NFC device 104. The firmware update data 122 can be loaded onto a memory and then install in the NFC device 104. Various methods can be utilized to provide firmware update data 122 to the NFC device 104, as described previously.

After the firmware update data 122 has been provided to the NFC device 104, the NFC device 104 is brought the proximity of the electronic system 123. The NFC reader 102 operates and reader mode and outputs a carrier signal and an interrogation signal. The NFC device 104 respond to the interrogation signal and NFC communication is established between NFC device 104 and the NFC reader 102. The NFC reader 102 reads identification data from the NFC device 104. After authentication, the NFC reader 102 reads the firmware update data 122 from the NFC device 104. The NFC reader 102 then provides the firmware update data 122 to the controller 124. The controller 124 updates the firmware data 128 with the firmware update data 122.

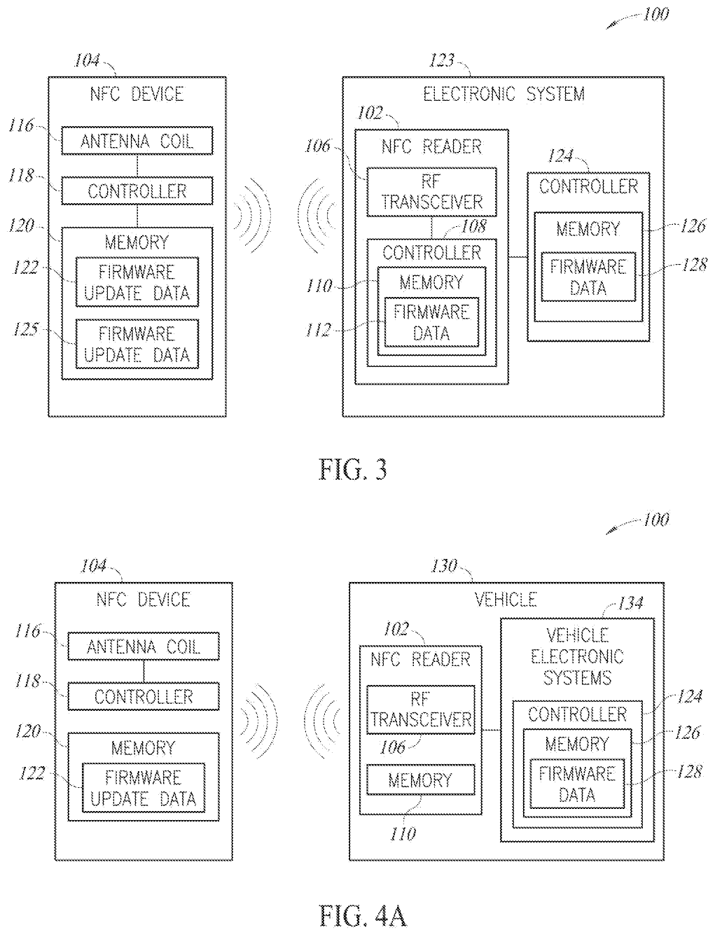

FIG. 3 is a block diagram of an NFC system 100, according to one embodiment. The NFC system includes an electronic system 123 and an NFC device 104. The electronic device 123 includes an NFC reader 102 and a controller 124. The NFC reader 102 includes a controller 108. The electronic device 123 and the NFC device 104 cooperate to update the firmware of the controller 108 and of the controller 124.

The NFC device 104 of FIG. 3 is substantially identical to the NFC device 104 of FIG. 1. The electronic system 123 is a system that hosts the NFC reader 102. The controller 108 controls the function of the NFC reader 102 includes a memory 110 and firmware data 112.

The controller 124 controls other aspects of the electronic system 123. The controller 124 includes a memory 126 and firmware data 128. The firmware data 128 effectively controls the function of the controller 124.

When a firmware update is available for the controller 108 and the controller 124, the NFC device 104 receives firmware update data 122 for the controller 108 and firmware update data 125 for the controller 124. The firmware update data 122 and 125 can be received by the NFC device 104 as described previously.

After the firmware update data 122 and 125 have been provided to the NFC device 104, the NFC device 104 is brought into proximity of the electronic system 123. The NFC reader 102 operates in reader mode and outputs a carrier signal and an interrogation signal. The NFC device 104 respond to the interrogation signal and NFC communication is established between NFC device 104 and the NFC reader 102. The NFC reader 102 reads identification data from the NFC device 104. After authentication, the NFC reader 102 reads the firmware update data 122 and the firmware update data 125 from the NFC device 104. The NFC reader 102 provides the firmware update data 122 to the controller 108. The controller 108 updates the firmware data 112 with the firmware update data 122 as described previously. The NFC reader 102 then provides the firmware update data 125 to the controller the controller 124 updates the firmware data 128 with the firmware update data 125.

In this way, the system 100 can update the firmware of the NFC reader 102 and of a controller associated with other aspects of the electronic system 123. Thus, the NFC reader 102 and the NFC device 104 can be utilized advantageously to not only update firmware associated with the NFC reader 102, but to update firmware associated with a controller 124 that performs other functions in electronic system 123. Accordingly, the NFC reader 102 and the controller 124 may be in wired or wireless communication with each other.

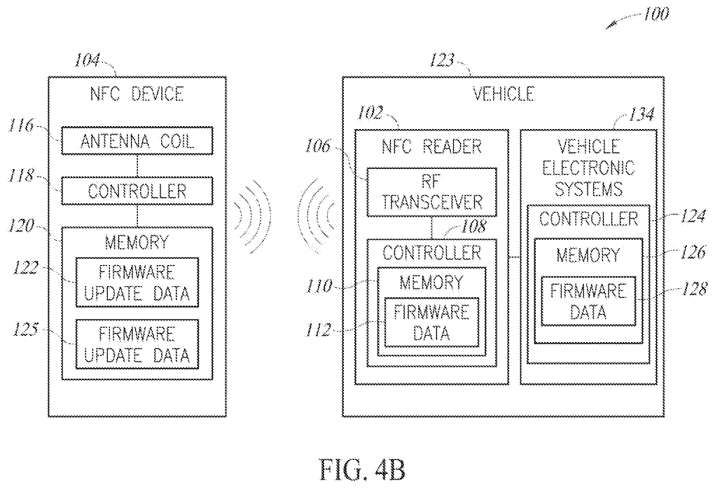

FIG. 4A is a block diagram of an NFC system 100, according to one embodiment. The NFC system includes a vehicle 130 and an NFC device 104. The vehicle 130 includes an NFC reader 102 and vehicle electronic systems 134. The vehicle electronic systems 134 include a controller 124. The vehicle 130 and the NFC device 104 cooperate to update the firmware of the controller 124.

The NFC device 104 of FIG. 4A is substantially identical to the NFC device 104 of FIG. 1. The vehicle 130 is a vehicle that hosts the NFC reader 102. The vehicle electronic systems 134 include a controller 124 controls the NFC reader 102. Alternatively, a controller 110 may control the NFC reader 102, while the controller 124 controls other aspects of the vehicle 130.

In one embodiment, the vehicle 130 is an automobile. The NFC reader 102 may enable a user of the NFC device 104 to unlock the vehicle 130 or to activate other features of the vehicle 130. In these cases, the NFC reader 102 reads identification data from the NFC device 104 and, after authentication of the NFC device 104, unlocks a vehicle or activates other aspects of the vehicle. The NFC device 104 may include a smart phone, a key fob, or other types of NFC capable devices. Advantageously, the NFC device 104 can be utilized to update firmware data 128 associated with the vehicle electronic systems 134. Alternatively, the vehicle 130 can include an aircraft, a watercraft, a motorcycle, an e-bike, or other types of vehicles.

When a firmware update is available for the controller 124, the NFC device 104 receives firmware update data 122 as described previously. After the firmware update data 122 has been provided to the NFC device 104, the NFC device 104 is brought the proximity of the vehicle 130. The NFC reader 102 operates in reader mode and outputs a carrier signal and an interrogation signal. The NFC device 104 respond to the interrogation signal and NFC communication is established between NFC device 104 and the NFC reader 102. The NFC reader 102 reads identification data from the NFC device 104. After authentication, the NFC reader 102 reads the firmware update data 122 from the NFC device 104. The NFC reader then provides the firmware update data 122 to the controller 124. The controller 124 updates the firmware data 128 with the firmware update data 122.

FIG. 4B is a block diagram of an NFC system 100, according to one embodiment. The NFC system includes a vehicle 130 and an NFC device 104. The vehicle 130 includes an NFC reader 102 and vehicle electronic systems 134. The vehicle electronic systems 134 include a controller 124. The NFC reader 102 includes a controller 108. The vehicle 130 and the NFC device 104 cooperate to update the firmware of the controller 108 and of the controller 124.

The NFC device 104 of FIG. 4B is substantially identical to the NFC device 104 of FIG. 2. The vehicle 130 is a vehicle that hosts the NFC reader 102. The controller 108 controls the function of the NFC reader 102 includes a memory 110 and firmware data 112. The controller 124 controls other aspects of the vehicle 130. The controller 124 includes a memory 126 and firmware data 128. The firmware data 128 effectively controls the function of the controller 124.

When a firmware update is available for the controller 108 and the controller 124, the NFC device 104 receives firmware update data 122 for the controller 108 and firmware update data 125 for the controller 124. The firmware update data 122 and 125 can be received by the NFC device 104 as described previously.

After the firmware update data 122 and 125 have been provided to the NFC device 104, the NFC device 104 is brought into proximity of the vehicle 130. The NFC reader 102 operates in reader mode and outputs a carrier signal and an interrogation signal. The NFC device 104 respond to the interrogation signal and NFC communication is established between NFC device 104 and the NFC reader 102. The NFC reader 102 reads identification data from the NFC device 104. After authentication, the NFC reader 102 reads the firmware update data 122 and the firmware update data 125 from the NFC device 104. The NFC reader 102 provides the firmware update data 122 to the controller 108. The controller 108 updates the firmware data 112 with the firmware update data 122 as described previously. The NFC reader 102 then provides the firmware update data 125 to the controller the controller 124 updates the firmware data 128 with the firmware update data 125.

In this way, the system 100 can update the firmware of the NFC reader 102 and of a controller associated with other aspects of the vehicle 130. Thus, the NFC reader 102 and the NFC device 104 can be utilized advantageously to not only update firmware associated with the NFC reader 102, but to update firmware associated with a controller 124 that performs other functions in electronic system 123. Accordingly, the NFC reader 102 and the controller 124 may be in wired or wireless communication with each other.

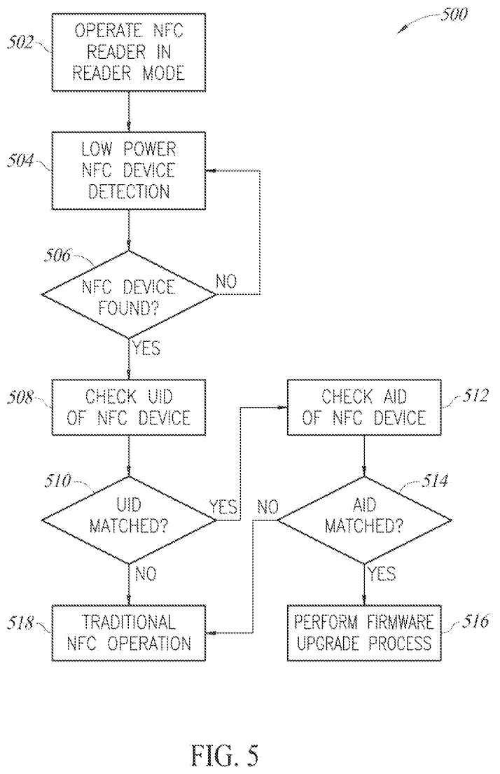

FIG. 5 is a flow diagram of a method 500 for operating an NFC system, according to one embodiment. The method 500 can utilize the systems, components, and processes described in relation to FIGS. 1-4. At 502, and NFC reader operates in reader mode. At 504, the NFC reader performs low power NFC device detection. This can include outputting the carrier signal and modulating the carrier signal from interrogation signal. At 506, if an NFC device is found by the NFC reader, then the process proceeds to 508. If the NFC reader does not find an NFC device, then the process remains at 504.

At 508, the NFC reader checks an identification of the NFC device. In one example, the identification is a UID. At 510, if the identification of the NFC device matches an identification stored by the NFC reader, and the process proceeds to 512. If the identification of the NFC device is not match the stored by the NFC reader, i.e. if the NFC device is not authenticated, the process proceeds to 518.

At 512, the NFC reader reads an AID, or another type of application or process identifier, from the NFC device. At 514, if the AID matches a firmware update AID, the process proceeds to 516. If the AID does not match a known AID, then the process proceeds to 518. At 516, the NFC reader performs a firmware upgrade process 516 by reading firmware update data from the NFC device and providing the firmware update data to a controller. The controller then updates its firmware data with the firmware update data. At 518, the reader performs traditional NFC operations.

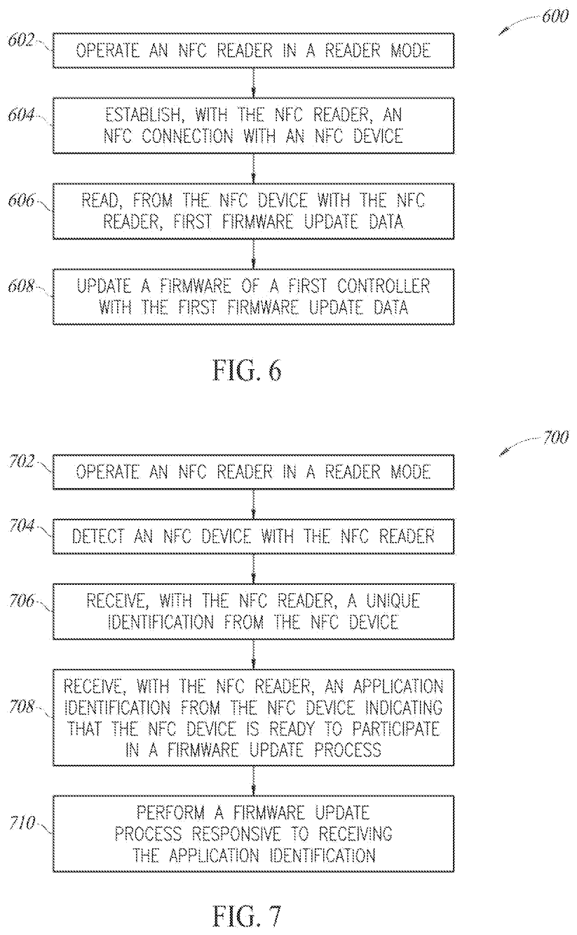

FIG. 6 is a flow diagram of a method 600 for operating an NFC system, according to one embodiment. The method 600 can utilize the systems, components, and processes described in relation to FIGS. 1-5. At 602, the method 600 includes operating an NFC reader in a reader mode. At 604, the method 600 includes establishing, with the NFC reader, an NFC connection with an NFC device. At 606, the method 600 includes reading, from the NFC device with the NFC reader, first firmware update data. At 608, the method 600 includes updating a firmware of a first controller with the first firmware update data.

FIG. 7 is a flow diagram of a method 700 for operating an NFC system, according to one embodiment. The method 700 can utilize the systems, components, and processes described in relation to FIGS. 1-6. At 702, the method 700 includes operating an NFC reader in a reader mode. At 704, the method 700 includes detecting an NFC device with the NFC reader. At 706, the method 700 includes receiving, with the NFC reader, a unique identification from the NFC device. At 708, the method 700 includes receiving, with the NFC reader, an application identification from the NFC device indicating that the NFC device is ready to participate in a firmware update process. At 710, the method 700 includes performing a firmware update process responsive to receiving the application identification.

In one embodiment, a method includes operating an NFC reader in a reader mode and establishing, with the NFC reader, an NFC connection with an NFC device. The method includes reading, from the NFC device with the NFC reader, first firmware update data and updating a firmware of a first controller with the first firmware update data.

In one embodiment, a method includes operating an NFC reader in a reader mode, detecting an NFC device with the NFC reader, and receiving, with the NFC reader, a unique identification from the NFC device. The method includes receiving, with the NFC reader, an application identification from the NFC device indicating that the NFC device is ready to participate in a firmware update process and performing a firmware update process responsive to receiving the application identification.

In one embodiment, an electronic system includes an NFC reader including an RF transceiver and a first controller including first firmware data, wherein the NFC reader is configured to operate in a reader mode, to establish communication with an NFC device, to read first firmware update data from the NFC device, and to provide the first firmware update data to the first controller.

In one embodiment, a vehicle includes an NFC reader including an RF transceiver and a first controller including first firmware data, wherein the NFC reader is configured to operate in a reader mode, to establish communication with an NFC device, to read first firmware update data from the NFC device, and to provide the first firmware update data to the first controller.

In one embodiment, an NFC reader includes an RF transceiver and controller including first firmware data. The NFC reader is configured to operate in a reader mode, to establish communication with an NFC device, to read firmware update data from the NFC device, and to provide the firmware update data to the first controller.

In one embodiment, an electronic system includes an NFC device configured to receive firmware update data, an NFC reader including an RF transceiver, and a first controller including first firmware data. The NFC reader is configured to operate in a reader mode, to establish communication with the NFC device, to read first firmware update data from the NFC device, and to provide the first firmware update data to the first controller.

In one embodiment, a method includes receiving, with an NFC device, firmware update data, establishing NFC communication with an NFC reader operating in reader mode, and providing the firmware update data to the NFC reader.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
operating a near field communication reader in a reader mode;
establishing, with the near field communication reader, a near field communication connection with a near field communication device;
reading, from the near field communication device with the near field communication reader, first firmware update data; and
updating a firmware of a first controller with the first firmware update data.

2. The method of claim 1, wherein the near field communication reader is part of an electronic system, and the updating the firmware of the first controller comprises updating firmware of a controller of the electronic system.

3. The method of claim 1, wherein the updating the firmware of the first controller comprises updating firmware of a controller of the near field communication reader.

4. The method of claim 1, comprising:
reading, from the near field communication device with the near field communication reader, second firmware data; and
updating a firmware of a second controller with the second firmware update data.

5. The method of claim 4, wherein,
the updating the firmware of the first controller comprises updating firmware of a controller of the near field communication reader; and
the updating the firmware of the second controller comprises updating firmware of a controller of an electronic system that includes the near field communication reader.

6. The method of claim 5, wherein the electronic system is part of a vehicle.

7. The method of claim 1, wherein the near field communication device is a mobile phone operating in a card emulation mode.

8. The method of claim 1, wherein establishing a near field communication connection with the near field communication device includes:
receiving a unique identification of the near field communication device with the near field communication reader; and
authenticating, with the near field communication reader, the unique identification of the near field communication.

9. The method of claim 8, wherein establishing a near field communication connection with the near field communication device includes:
receiving an application identification of the near field communication device with the near field communication reader; and
identifying that application identification refers to a firmware update process.

10. The method of claim 9, comprising updating the firmware of the first controller responsive to identifying that that the application identification corresponds to a firmware update process.

11. An electronic system, comprising:
a near field communication reader including a radiofrequency transceiver; and
a first controller including first firmware data, wherein the near field communication reader, in a reader mode of operation, establishes communication with a near field communication device, reads first firmware update data from the near field communication device, and provides the first firmware update data to the first controller.

12. The electronic system of claim 11, wherein the first controller, in operation, updates the first firmware data with the first firmware update data.

13. The electronic system of claim 11, wherein the first controller is a controller of the near field communication reader.

14. The electronic system of claim 12, comprising a second controller including second firmware data, wherein the near field communication reader, in operation, reads second firmware update data from the near field communication device and provides the second firmware update data to the second controller.

15. The electronic system of claim 14, wherein the second controller, in operation, updates the second firmware with the second firmware update data.

16. The electronic system of claim 14, wherein the first controller, in operation, controls the near field communication reader, and the second controller, in operation, controls functions of the electronic system.

17.-21. (canceled)

22. A method, comprising:
operating a near field communication reader in a reader mode;
detecting a near field communication device with the near field communication reader;
receiving, with the near field communication reader, a unique identification from the near field communication device;
receiving, with the near field communication reader, an application identification from the near field communication device indicating that the near field communication device is ready to participate in a firmware update process; and
performing a firmware update process responsive to receiving the application identification.

23.-30. (canceled)

31. A method, comprising:
receiving, with a near field communication device, firmware update data;
establishing near field communication with a near field communication reader operating in reader mode; and
providing the firmware update data to the near field communication reader, wherein the firmware update data is for a controller of the near field communication reader

32. (canceled)

33. The electronic system of claim 11, comprising a vehicle, wherein the near field communication reader is part of the vehicle.

34. The electronic system of claim 11, comprising the near field communication device.
